(19) United States
(12) Patent Application Publication
(10) Pub. No.: US 2026/0267706 A1
(43) Pub. Date: Sep. 10, 2026

(54) SYSTEMS FOR ARCHITECTURAL MEMORY BOTTLENECK DETECTION, INVERSE CORRELATION ANALYSIS, AND PREDICTIVE MEMORY GOVERNANCE IN GRAPHICS PROCESSING UNITS

(71) Applicant: Austin Murray Johnson, Lilburn, GA (US)

(72) Inventor: Austin Murray Johnson, Lilburn, GA (US)

(21) Appl. No.: 19/560,292

(22) Filed: Mar. 9, 2026

Related U.S. Application Data
(60) Provisional application No. 63/768,942, filed on Mar. 8, 2025.

(51) Int. Cl. G06F 9/50; G06F 9/30

(52) U.S. Cl. CPC G06F 9/5044; G06F 9/30038; G06F 9/5016

(57) ABSTRACT

A graphics processing unit system includes monitoring logic configured to measure achieved throughput and memory access latency, and a control unit configured to detect bottleneck conditions by comparing achieved throughput to peak sustainable throughput. The system dynamically modifies architectural parameters including active processing core count to mitigate bottlenecks. In certain embodiments, inverse correlation between bottleneck intensity and latency is detected and used to govern reconfiguration. In other embodiments, a Markov-chain predictive state-transition model sequences memory block access to reduce stall cycles and improve cache utilization. The invention provides hardware-grounded architectural governance for improving memory hierarchy efficiency in GPU systems.

### CROSS-REFERENCE TO RELATED APPLICATIONS

This application claims priority to U.S. Provisional Patent Application No. 63/768,942, filed Mar. 8, 2025, entitled “Enhancing GPU-HBM Data Transfer Efficiency via Optimization of V100 Architecture and NN-driven Markov-Based Predictive Caching with Quantization and Pruning,” the entire disclosure of which is incorporated herein by reference.

### FIELD OF THE INVENTION

The present invention relates to graphics processing units (GPUs) and GPU-based computing systems. More particularly, the invention relates to hardware-integrated systems and computer-readable storage media for detecting architectural memory hierarchy bottlenecks, determining inverse relationships between bottleneck intensity and memory access latency, dynamically modifying execution resource allocation, and implementing predictive memory sequencing models for reducing memory-induced inefficiencies in GPU architectures.

### BACKGROUND OF THE INVENTION

High-performance GPUs used in artificial intelligence and data-intensive workloads frequently experience inefficiencies arising from architectural data transfer bottlenecks. A bottleneck occurs when a processing unit receives data at a rate that exceeds its sustainable processing or emission rate, thereby limiting achieved throughput below expected performance capacity.

In GPU architectures, such inefficiencies often arise within the memory hierarchy. The time required to sort, access, or retrieve data from memory may exceed the time required to perform computational operations, preventing the GPU from fully utilizing its available processing cores and memory bandwidth.

Conventional systems rely on static architectural configurations, fixed numbers of active cores, or workload-specific tuning. These approaches fail to adapt dynamically to changing input sizes and runtime memory pressure conditions.

Additionally, empirical testing has revealed that under certain architectural conditions, bottleneck intensity may increase while measured latency decreases, suggesting a counterintuitive inverse relationship between bottleneck intensity and latency metrics. Traditional monitoring systems fail to detect or utilize this inverse correlation.

Accordingly, there exists a need for hardware-grounded governance systems capable of detecting bottlenecks through throughput comparison, identifying inverse correlation patterns, dynamically modifying architectural parameters including core activation, and optionally implementing predictive memory sequencing models to mitigate inefficiencies.

### SUMMARY OF THE INVENTION

The present invention provides systems and architectures for detecting and mitigating architectural memory bottlenecks in graphics processing units through hardware-integrated governance mechanisms. The invention operates by computing achieved throughput relative to a stored peak sustainable throughput value, determining throughput deficiency, computing composite bottleneck intensity using multiple performance indicators, and dynamically modifying architectural parameters in response to sustained deviation conditions. A control Unit may compute bottleneck intensity as a composite function of throughput deficiency and stall cycle metrics.

In one embodiment, monitoring circuitry computes achieved throughput and stall cycle metrics during defined sampling intervals. Monitoring circuitry (i.e., monitoring logic) computes stall cycle metrics by counting cycles during which a streaming multiprocessor cannot issue instructions due to unresolved memory dependencies. A control unit computes throughput deficiency as the difference between achieved throughput and a stored peak sustainable throughput value representing calibrated architectural capacity. The control unit further computes a composite bottleneck intensity using weighted combinations of throughput deficiency and stall cycle metrics. When the composite bottleneck intensity exceeds one or more programmable thresholds for a sustained interval, architectural modification is initiated.

In another embodiment, configuration circuitry dynamically adjusts the number of active streaming multiprocessors in order to align computational concurrency with memory hierarchy capacity. Reducing the number of active streaming multiprocessors decreases concurrent memory request pressure and reduces queue congestion, while increasing active multiprocessors increases computational throughput when memory capacity is underutilized.

In another embodiment, arbitration micro-architecture within a shared cache and memory channel controller is dynamically modified. Arbitration weight registers and bandwidth allocation parameters are adjusted in response to composite bottleneck intensity, thereby prioritizing latency-sensitive memory transactions and reducing stall cycle accumulation.

In another embodiment, inverse correlation detection logic evaluates the statistical relationship between bottleneck intensity and latency metrics across sliding time windows. When a statistically significant negative correlation is detected, weighting coefficients used in bottleneck intensity computation are modified to emphasize stall-based metrics over latency-only metrics, thereby preventing misinterpretation of transient latency fluctuations.

In another embodiment, a predictive state-transition model based on a Markov chain is integrated into the governance loop. Historical memory access sequences are used to compute transition probabilities between memory block states. Predicted future memory accesses are identified, and prefetch control signals are generated to retrieve memory blocks prior to explicit load instruction issuance. Reduced cache miss rates and reduced stall cycles feed back into composite bottleneck intensity calculations, forming a closed-loop mitigation system.

The invention therefore provides a hardware-grounded, closed-loop architectural governance system that detects throughput deficiency relative to peak sustainable throughput and dynamically modifies compute resources, arbitration parameters, and predictive memory sequencing in order to restore operation toward architectural capacity.

### BRIEF DESCRIPTION OF THE DRAWINGS

FIG. 1 illustrates a graphics processing unit architecture including monitoring logic, control circuitry, execution units, configuration circuitry, shared cache structures, memory channel interfaces, and global memory resources interconnected in a closed-loop governance system.

FIG. 2 illustrates predictive memory sequencing circuitry including a state-transition model, transition probability storage structures, prediction logic, and prefetch control generation integrated into the architectural bottleneck mitigation loop using a Markov Chain Matrix.

### DETAILED DESCRIPTION OF THE INVENTION

The present invention provides a hardware-governed architectural system configured to detect, quantify, interpret, and mitigate memory hierarchy bottlenecks in graphics processing units. The system operates by continuously monitoring achieved throughput, computing throughput deficiency relative to peak sustainable throughput, calculating bottleneck intensity using composite metrics, detecting sustained inefficiency conditions, evaluating correlation patterns including inverse correlation conditions, and dynamically modifying architectural resources including core activation, cache arbitration parameters, memory channel allocation, and predictive prefetch sequencing.

The system is implemented using conventional GPU hardware elements, including streaming multiprocessors, cache controllers, memory controllers, arbitration logic, interconnect fabrics, programmable registers, arithmetic logic units, hardware counters, and state machines. Conventional examples include NVIDIA® V100 streaming multiprocessors, shared L2 cache controllers, HBM2 memory controllers, and programmable performance monitoring registers. The invention does not require modification of fundamental GPU arithmetic circuitry, but rather integrates governance logic into existing architectural pathways.

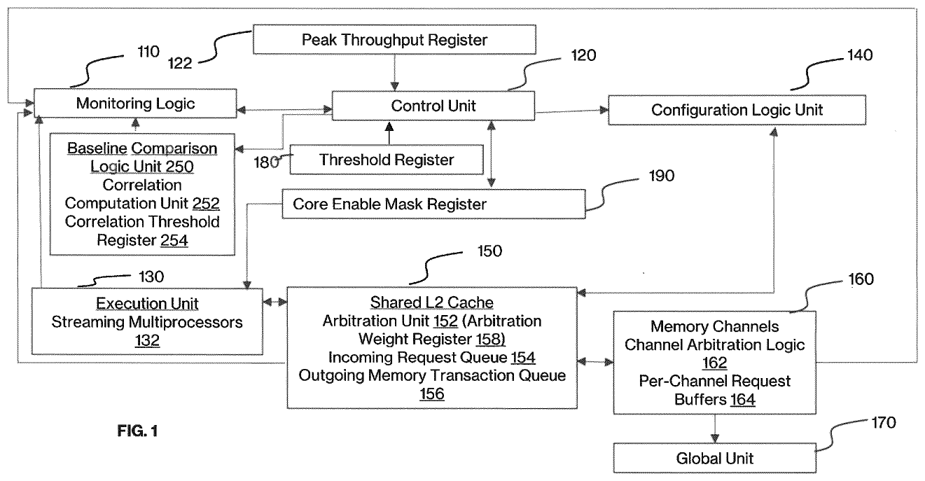

As shown in FIG. 1, GPU Memory Bottleneck Governance System 100 includes Monitoring Logic 110, Control Unit 120, Execution Unit 130, Configuration Logic Unit 140, Shared L2 Cache 150, Memory Channels 160, and Global Memory 170.

Monitoring Logic 110 is electrically connected to Control Unit 120 via a bidirectional performance and control bus. Control Unit 120 is electrically connected to Execution Unit 130 through a configuration and control interface including Core Enable Mask Register 190. Execution Unit 130 is electrically connected to Shared L2 Cache 150 through a memory request interface. Shared L2 Cache 150 is electrically connected to Memory Channels 160 via memory transaction lines. Memory Channels 160 are electrically connected to Global Memory 170 via high-bandwidth memory signaling interfaces.

Execution Unit 130 includes Streaming Multiprocessors 132, which are conventional parallel processing clusters containing arithmetic logic units, load/store units, register files, warp schedulers, and instruction issue logic. Streaming multiprocessors 132 executes multiple threads in parallel and generates memory request signals when encountering load or store instructions.

When a load instruction is issued, Streaming Multiprocessor 132 transmits a memory request signal containing address information and transaction identifiers to Shared L2 Cache 150. Shared L2 Cache 150 evaluates tag arrays and either generates a cache hit response or forwards a memory transaction request to Memory Channels 160.

Memory Channels 160 include arbitration units that determine which pending memory transactions are forwarded to Global Memory 170. Arbitration may be based on round-robin scheduling, priority weighting, queue depth analysis, or programmable arbitration policies.

Monitoring Logic 110 receives execution completion signals from Execution Unit 130, memory completion signals from Memory Channels 160, and stall indicators from instruction issue logic within Streaming Multiprocessors 132.

A memory completion signal is defined as a hardware signal generated by Memory Channels 160 indicating that a requested memory transaction has been completed and data has been returned to Shared L2 Cache 150 and subsequently to the requesting Streaming Multiprocessor 132. The memory completion signal includes transaction ID and completion timestamp.

Monitoring Logic 110 computes throughput metrics by counting completed instruction retirements per defined sampling interval. A sampling interval may be programmable, such as 10,000 clock cycles or 1 millisecond of runtime.

Latency monitor outputs are computed by subtracting request issuance timestamp from completion timestamp for each memory transaction. Latency is defined as the delay between memory request transmission and corresponding data return.

Stall cycle metrics are computed by counting cycles during which Streaming Multiprocessor 132 is unable to issue instructions because of unresolved memory dependencies. Memory dependencies are the unresolved data dependencies that prevent an instruction from issuing until a prior memory transaction returns the needed data. A stall cycle is detected when instruction issue logic signals that no instruction can be dispatched due to pending data.

Monitoring Logic 110 computes latency monitor outputs by subtracting the request issuance timestamp from the completion timestamp for each memory transaction. Monitoring Logic 110 transmits throughput metrics, latency monitor outputs, and stall cycle metrics to Control Unit 120.

Control Unit 120 retrieves peak throughput value from Peak Throughput Register 122. A peak sustainable throughput value is determined during a calibration phase under reduced memory congestion conditions. Peak throughput value represents maximum sustainable throughput under ideal memory servicing conditions. An “ideal memory servicing conditions” are the conditions under which peak throughput represents the maximum sustainable throughput, i.e., the calibrated architectural capacity under reduced/non-congested memory conditions.

Throughput deficiency is computed as peak throughput minus achieved throughput. Achieved throughput is derived from throughput metrics. Achieved Throughput may be computed from the throughput metrics produced by monitoring logic. For example, monitoring logic circuitry may count completed instruction retirements per sampling interval to produce throughput metrics, and achieved throughput is then “derived” from those metrics.

Throughput deficiency represents the quantitative difference between expected architectural capacity and observed performance.

Severity of deviation is defined as the ratio of throughput deficiency to peak throughput value, representing percentage underutilization.

Bottleneck intensity is computed as a composite function of throughput deficiency and stall cycle metrics. In one embodiment, bottleneck intensity equals (throughput deficiency×α)+(stall cycles×β), where α and β are programmable weighting coefficients stored in Threshold Registers 180.

Threshold Registers 180 store programmable threshold values defining acceptable upper bounds for bottleneck intensity and acceptable lower bounds for achieved throughput.

A programmable threshold is defined as a threshold value stored in a writable hardware register capable of being modified via firmware, driver interface, or configuration protocol.

Control Unit 120 compares bottleneck intensity to threshold values stored in Threshold Registers 180.

If Bottleneck intensity exceeds threshold for a sustained interval defined as multiple consecutive sampling windows, Control Unit 120 generates bottleneck detection signal.

Bottleneck detection signal is a hardware control signal transmitted to Configuration Logic Unit 140 indicating that architectural mitigation must be initiated.

As further shown in FIG. 1, Shared L2 Cache 150 includes an internal Arbitration Unit 152 electrically connected to an Incoming Request Queue 154 and an Outgoing Memory Transaction Queue 156. Incoming Request Queue 154 receives memory request signals transmitted from Streaming Multiprocessors 132 through Execution Unit 130. Outgoing Memory Transaction Queue 156 transmits cache-miss transactions to Memory Channels 160.

Arbitration Unit 152 may further include a programmable arbitration weight register storing per-streaming-multiprocessor priority weights. Arbitration Weight Register 158 is electrically connected to Configuration Logic Unit 140 via arbitration configuration lines.

Arbitration Unit 152 evaluates pending memory requests stored in Incoming Request Queue 154 using weighted arbitration logic. In one embodiment, Arbitration Unit 152 computes a weighted score for each pending request as:

Priority Score=Base Priority×Arbitration Weight×Queue Aging Factor,

wherein the queue aging factor may be a priority score logic that increases over time to prevent starvation.

Base Priority may be derived from request type (e.g., load, store, atomic), arbitration weight is retrieved from Arbitration Weight Register 158, and Queue Aging Factor increases over time to prevent starvation.

Arbitration Unit 152 selects a request for forwarding to Outgoing Memory Transaction Queue 156 based on highest computed Priority Score.

Configuration Logic Unit 140 modifies Arbitration Weight Register 158 in response to Reconfiguration control directives received from Control Unit 120. Control Unit 120 provides/transmits reconfiguration control directives when Bottleneck Detection Signal 118 has been asserted and sustained. Specifically, when bottleneck intensity exceeds threshold, i.e, when the computed Bottleneck Intensity value is greater than the stored threshold value used by Control Unit 120 for comparison, and throughput deficiency indicates compute underutilization due to memory congestion, Configuration Logic Unit 140 increases weight values associated with latency-sensitive execution streams and reduces weights associated with bulk memory traffic streams. That is, configuration Logic 140 rewrites Arbitration Weight Register 158 so that the Arbitration Unit 152's weighted arbitration prioritizes memory requests that are likely to unblock execution (“latency-sensitive”) and de-prioritizes bulk traffic, thereby changing which requests win arbitration.

This arbitration modification reduces stall cycles by prioritizing requests that unblock execution units, thereby lowering Stall cycle metrics and reducing Throughput Deficiency in subsequent sampling windows. “Arbitration modification” refers to the change to the arbitration behavior produced by modifying Arbitration Weight Register 158 (and thus the priority scores/selections performed by Arbitration Unit 152).

The modified arbitration weights directly affect the composition of memory transactions forwarded to Memory Channels 160, thereby influencing queue depth distribution and reducing localized congestion within memory scheduling pipelines.

Memory Channels 160 include Channel Arbitration Logic 162 electrically connected to Per-Channel Request Buffers 164. Each Memory Channel 160 services one or more banks of Global Memory 170 and includes conventional row-buffer management and scheduling logic.

Channel Arbitration Logic 162 computes scheduling decisions based on a channel scheduling policy, which may include first-ready first-come-first-served (FR-FCFS), round-robin, or weighted fair queuing. A channel scheduling policy may be data is used by Channel Arbitration Logic 162 to compute scheduling decisions (examples listed: FR-FCFS, round-robin, weighted fair queuing).

Configuration Logic Unit 140 transmits channel rebalancing signals to Channel Arbitration Logic 162 when Reconfiguration control directives indicate sustained Bottleneck Intensity attributable to memory channel saturation.

Channel Rebalancing Signals modify channel bandwidth allocation ratios, enabling redistribution of transaction load across multiple memory channels to reduce hotspot congestion.

Redistribution of bandwidth reduces queue accumulation within Per-Channel Request Buffers 164, thereby reducing latency variance and decreasing stall cycle metrics.

Following modification of Arbitration Weight Register 158 and channel scheduling policy, updated memory completion signals are transmitted to Monitoring Logic 110.

Monitoring Logic 110 recomputes latency monitor outputs and stall cycle metrics. Control Unit 120 recomputes bottleneck intensity using updated values and compares the result against Threshold Registers 180.

If bottleneck intensity decreases below threshold during subsequent sustained intervals, Control Unit 120 may restore default arbitration weights gradually to prevent oscillatory behavior. Default arbitration weights are the baseline weight values (stored in Arbitration Weight Register 158) that the system returns toward once bottleneck intensity drops below threshold, to avoid oscillation while restoring normal fairness/throughput behavior.

This dynamic arbitration modulation distinguishes the invention from systems that merely monitor performance counters without modifying arbitration micro-architecture in response to composite throughput deficiency metrics.

As further shown in FIG. 1, Execution Unit 130 is electrically connected to Configuration Logic Unit 140 through Core Enable Mask Register 190, and Configuration Logic Unit 140 is electrically connected to Shared L2 Cache 150 and Arbitration Unit 152 through dedicated configuration buses.

Execution Unit 130 includes Streaming Multiprocessors 132, which are conventional parallel execution clusters comprising arithmetic logic units, register files, instruction schedulers, load/store units, and warp control logic. Each Streaming Multiprocessor 132 receives an enable signal from Core Enable Mask Register 190 that determines whether one of Streaming Multiprocessor 132 is permitted to issue instructions.

Core Enable Mask Register 190 is a programmable hardware register storing a bitmask in which each bit corresponds to an activation state of a Streaming Multiprocessor 132. A logical “1” in a bit position indicates that the corresponding that one of Streaming Multiprocessors 132 that is active and permitted to issue instructions, while a logical “0” indicates that one of the Streaming Multiprocessors 132 that is disabled and prevented from issuing instructions.

Control Unit 120 transmits reconfiguration control directives to Configuration Logic Unit 140 when bottleneck detection signal has been asserted and sustained for a defined interval. Reconfiguration control directives include structured fields specifying a target number of active Streaming Multiprocessors 132, cache partition adjustments, and arbitration weight adjustments.

Configuration Logic Unit 140 receives reconfiguration control directives and computes a Core Adjustment Vector indicating which Streaming Multiprocessors 132 should transition from active to inactive state or vice versa. The Core Adjustment Vector is transmitted to Core Enable Mask Register 190 via a control bus.

Upon receipt of the Core Adjustment Vector, Core Enable Mask Register 190 updates its stored bitmask and transmits activation or deactivation signals to corresponding Streaming Multiprocessors 132. Deactivation signals cause instruction issue logic within the Streaming Multiprocessor to enter a quiescent state in which no new instructions are dispatched, although architectural state is preserved.

Reducing the number of active Streaming Multiprocessors 132 reduces the number of concurrent memory request signals transmitted to Shared L2 Cache 150. Because each active Streaming Multiprocessor may generate multiple outstanding memory requests, deactivation decreases memory request concurrency and reduces queue depth in Incoming Request Queue 154.

Reduced queue depth lowers contention within Arbitration Unit 152 and reduces queuing latency within Memory Channels 160. As a result, latency monitor outputs decrease in variance, stall cycle metrics decrease in magnitude, and throughput deficiency is reduced in subsequent sampling windows. Reduced queue depth means less accumulation of pending requests/transactions in the memory scheduling queues—particularly reduced queue accumulation within Per-Channel Request Buffers 164—which reduces latency variance and helps reduce stall cycles.

Conversely, when throughput deficiency indicates underutilization without high stall cycle metrics, Configuration Logic Unit 140 may increase the number of active Streaming Multiprocessors 132 to improve parallel throughput. In such case, Core Enable Mask Register 190 sets additional bits to logical “1,” enabling additional execution clusters to issue instructions. As used herein, high stall cycle metrics may mean the count of “cycles during which the Streaming Multiprocessor 132 is unable to issue instructions because of unresolved memory dependencies” is high—i.e., a large fraction of time the a streaming multiprocessor is blocked waiting on memory.

In addition to core activation adjustments, Configuration Logic Unit 140 may transmit cache partition signals to Shared L2 Cache 150. Cache Partition Signals specify allocation ratios for cache ways assigned to different Streaming Multiprocessors 132 or traffic classes. Adjusting cache partitions reduces thrashing behavior and improves effective cache utilization.

Configuration Logic Unit 140 may also transmit arbitration weight update Signals to Arbitration Weight Register 158. These arbitration weight update signals modify weight coefficients used by Arbitration Unit 152 to prioritize latency-sensitive memory requests.

Each modification made by Configuration Logic Unit 140 is followed by transmission of updated performance signals from Monitoring Logic 110, ensuring that the effect of each architectural adjustment is quantifiably measured and incorporated into subsequent bottleneck intensity calculations.

As further shown in FIG. 1, a Baseline Comparison Logic Unit 250 is electrically connected to Control Unit 120 and Monitoring Logic 110. Baseline Comparison Logic Unit 250 receives bottleneck Intensity, latency monitor outputs, and stall cycle metrics over a performance metrics bus.

Baseline Comparison Logic Unit 250 includes a Correlation Computation Unit 252 and a Correlation Threshold Register 254. Correlation Threshold Register 254 stores programmable magnitude thresholds used to determine significance of correlation coefficients.

Correlation Computation Unit 252 computes correlation between bottleneck intensity and latency monitor outputs using a sliding window of performance samples. For each window, the unit calculates covariance between the two metrics and normalizes by the product of their standard deviations to compute a correlation coefficient.

Inverse correlation is defined as a statistically significant negative correlation in which bottleneck intensity increases across successive sampling windows while latency monitor outputs decrease or remain below latency threshold values. Such conditions may arise when memory arbitration temporarily reduces latency for some transactions while overall throughput remains constrained.

Correlation Computation Unit 252 transmits a correlation coefficient Signal to Control Unit 120. Control Unit 120 compares the magnitude of the correlation coefficient signal to values stored in Correlation Threshold Register 254.

If the correlation coefficient is negative and its absolute magnitude exceeds the programmable threshold, Control Unit 120 determines that inverse correlation condition exists.

Upon detecting inverse correlation, Control Unit 120 modifies bottleneck intensity weighting coefficients stored in Threshold Registers 180. Specifically, Control Unit 120 may increase weight β applied to stall cycle metrics and decrease reliance on raw latency monitor outputs.

By adjusting weighting factors, Control Unit 120 ensures that decisions are based on sustained execution stall behavior rather than transient latency fluctuations. This prevents false interpretation of temporary latency decreases as performance improvement when Throughput Deficiency remains high.

The modified weighting coefficients directly influence subsequent Bottleneck Intensity calculations, ensuring that the correlation detection logic feeds back into the control loop and affects future reconfiguration decisions.

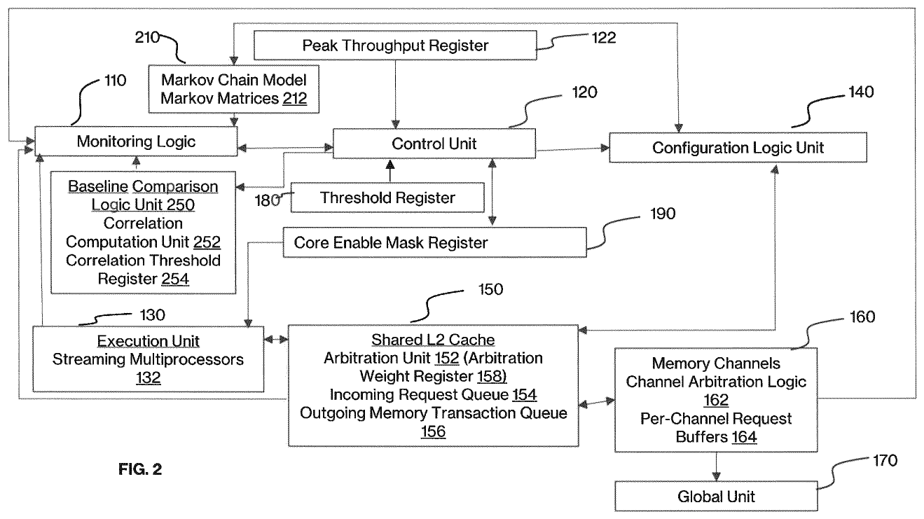

As shown in FIG. 2, a Markov Chain Model 210 may be electrically connected to Monitoring Logic 110 and Configuration Logic Unit 140. Markov Matrices 212 are electrically connected to Markov Chain Model 210 and store transition probability values in matrix form.

Monitoring Logic 110 transmit may memory access history signals to Markov Chain Model 210. Memory Access History Signals include identifiers corresponding to recently accessed memory blocks within Shared L2 Cache 150 or Global Memory 170.

Markov Chain Model 210 maintains a transition count table storing counts of observed transitions from a memory block A to a memory block B, wherein memory block A and memory block B are memory blocks withing Shared L2 Cashe 150 or Global Memory 170. Monitoring Logic 110 may transmit a sequence of memory block identifiers to Markov Chain Model 210 for incrementing corresponding transition count entries.

Transition probabilities stored in Markov Matrices 212 are computed by dividing transition count from state A to state B by total transitions originating from state A. These probabilities are periodically normalized to ensure that each row of Markov Matrices 212 sums to one.

Markov Chain Model 210 maintains a current state vector representing probability distribution of present memory access state. The model multiplies current state vector by Markov Matrices 212 to compute a predicted state distribution.

The predicted state distribution identifies memory blocks with highest probability of imminent access. Markov Chain Model 210 selects top-ranked memory blocks exceeding a programmable confidence threshold.

Markov Chain Model 210 generates prefetch control signals and transmits the prefetch control signals to Configuration Logic Unit 140. Prefetch control signals include predicted memory block address, confidence value, and priority class.

Configuration Logic Unit 140 receives prefetch control signals and issues prefetch command signals to shared L2 Cache 150 or directly to Memory Channels 160. Prefetch command signals instruct cache controller to load specified memory blocks into cache prior to explicit request issuance.

Prefetched memory blocks are inserted into Shared L2 Cache 150 using replacement logic that preserves high-reuse cache lines. This reduces cache miss rate and reduces subsequent Latency monitor outputs.

Reduced latency lowers stall cycle metrics because Streaming Multiprocessors 132 receive data sooner and resume instruction issuance earlier.

Reduced stall cycle metrics and improved achieved throughput are transmitted back to Monitoring Logic 110, which recomputes Throughput Deficiency and Bottleneck Intensity, thereby closing the predictive feedback loop.

Because Markov Chain Model 210 integrates directly with bottleneck intensity reduction mechanisms and core activation logic, predictive prefetching is not merely speculative caching but part of an architectural governance loop designed to restore throughput toward peak sustainable capacity.

The invention solves the architectural bottleneck problem by detecting throughput deficiency relative to peak sustainable throughput, computing severity of deviation using composite Bottleneck Intensity metrics, confirming sustained inefficiency, dynamically modifying core activation and arbitration parameters to reduce memory request congestion, detecting inverse correlation conditions to prevent misinterpretation of latency behavior, and optionally implementing predictive Markov-based prefetching to reduce cache misses and stall cycles. By aligning compute resource intensity with memory hierarchy capacity and by proactively sequencing memory accesses, the system eliminates the condition in which achieved throughput is limited by architectural imbalance, thereby restoring operation toward peak sustainable throughput

In certain embodiments, the invention utilizes architectural components that are conventional in graphics processing unit design. These conventional components are described below for completeness and to clarify that the novelty of the present invention does not reside in the individual components themselves, but rather in the coordinated control architecture and closed-loop governance system described herein.

Streaming multiprocessors are conventional parallel execution units found in modern graphics processing units. A streaming multiprocessor typically includes arithmetic logic units, floating-point units, integer execution units, load/store units, warp schedulers, register files, instruction issue logic, and pipeline control circuitry. Such streaming multiprocessors are configured to execute multiple threads concurrently and to generate memory access requests when executing load and store instructions.

Shared cache structures, including shared L2 caches, are conventional memory hierarchy components including tag arrays, data arrays, replacement policy logic, hit/miss detection circuitry, and cache line fill logic. Shared caches are electrically interconnected with streaming multiprocessors and memory controllers and are configured to service memory requests or forward cache-miss transactions to lower memory levels.

Memory channels and memory controllers are conventional components configured to schedule, arbitrate, and transmit memory transactions to external memory devices such as high-bandwidth memory or graphics double data rate memory. Memory controllers commonly include request buffers, row-buffer management circuitry, scheduling logic, and channel arbitration units.

Arbitration logic within shared caches and memory controllers is conventional and may implement weighted round-robin scheduling, priority-based selection, queue aging factors, or bandwidth partitioning schemes. Arbitration weight registers storing programmable weighting coefficients are also conventional.

Performance monitoring logic, including hardware counters and timestamp registers, is conventional and may be configured to count instructions retired, memory transactions issued, cache hits and misses, stall cycles, and latency intervals between request issuance and completion.

Core enable mask registers or execution gating registers are conventional hardware registers configured to enable or disable execution units for purposes including power management, fault isolation, or workload partitioning.

Transition probability tables and state-transition matrices, including Markov-based transition matrices, are conventional mathematical structures used in predictive modeling, including branch prediction and memory prefetching systems.

Prefetch engines are conventional subsystems configured to receive predicted memory addresses and issue prefetch commands to load cache lines prior to explicit instruction demand.

Although the foregoing components are individually conventional, the present invention does not claim novelty in any single architectural element. Rather, novelty resides in the coordinated, closed-loop control architecture that:
(1) computes throughput deficiency relative to a stored peak sustainable throughput value representing calibrated architectural capacity;
(2) computes a composite bottleneck intensity using both throughput deficiency and stall cycle metrics;
(3) requires that the composite bottleneck intensity exceed a programmable threshold for a sustained interval before architectural modification is initiated;
(4) dynamically modifies the number of active streaming multiprocessors in response to the composite bottleneck intensity;
(5) dynamically modifies arbitration weights within shared cache and memory channel arbitration logic in response to the composite bottleneck intensity;
(6) detects statistically significant inverse correlation between bottleneck intensity and latency and modifies decision weighting accordingly; and
(7) integrates predictive state-transition modeling into the same composite bottleneck mitigation loop such that reductions in stall cycles are fed back into the throughput deficiency computation.

The coordinated interaction of these elements forms a closed-loop architectural governance system that restores operation toward peak sustainable throughput. The novelty therefore resides in the specific structural interconnection and signal-driven feedback architecture, rather than in any conventional hardware component in isolation.

The adaptive reconfiguration logic of the present invention modifies compute resource supply and cache arbitration parameters. The inverse correlation detection logic ensures correct interpretation of performance metrics when latency and bottleneck intensity exhibit counterintuitive relationships. The predictive Markov architecture of proactively reduces memory stalls by sequencing memory block accesses according to probabilistic transition models. Each figure integrates into a unified closed-loop system in which performance metrics are measured, interpreted, acted upon, and re-measured to verify reduction of throughput deficiency relative to peak sustainable throughput.

We claim:

1. A graphics processing unit system comprising:
a plurality of streaming multiprocessors configured to execute threads and generate memory access requests;
a memory hierarchy including a shared cache and at least one memory channel coupled to external memory;
monitoring logic configured to compute achieved throughput over defined sampling intervals and to compute stall cycle metrics indicating cycles during which a streaming multiprocessor is prevented from issuing instructions due to pending memory transactions;
a peak throughput register storing a peak sustainable throughput value representing calibrated architectural capacity under non-congested memory conditions;
a control unit configured to:
(i) compute throughput deficiency as a difference between the peak sustainable throughput value and the achieved throughput,
(ii) compute a composite bottleneck intensity based on both the throughput deficiency and the stall cycle metrics, and
(iii) determine whether the composite bottleneck intensity exceeds a programmable threshold for a sustained interval comprising multiple consecutive sampling intervals; and
configuration logic configured to dynamically modify a number of active streaming multiprocessors in response to the determination that the composite bottleneck intensity exceeds the programmable threshold for the sustained interval.

2. The system of claim 1, wherein the composite bottleneck intensity is computed using weighted coefficients applied respectively to throughput deficiency and stall cycle metrics.

3. The system of claim 1, wherein the sustained interval comprises at least five consecutive sampling intervals.

4. The system of claim 1, wherein dynamically modifying the number of active streaming multiprocessors comprises disabling at least one streaming multiprocessor by updating a core enable mask register.

5. The system of claim 1, wherein dynamically modifying the number of active streaming multiprocessors comprises enabling additional streaming multiprocessors when throughput deficiency is below the programmable threshold.

6. The system of claim 1, wherein the peak sustainable throughput value is determined during a calibration phase under reduced memory congestion conditions.

7. The system of claim 1, wherein the control unit recomputes composite bottleneck intensity following modification of active streaming multiprocessors to verify reduction of throughput deficiency.

8. The system of claim 1, wherein the configuration logic further adjusts cache partition allocations among streaming multiprocessors in response to composite bottleneck intensity.

9. A graphics processing unit system comprising:
a plurality of streaming multiprocessors;
a shared cache including arbitration logic and a programmable arbitration weight register;
monitoring logic configured to compute achieved throughput and stall cycle metrics;
a control unit configured to compute throughput deficiency relative to a stored peak sustainable throughput value and to compute composite bottleneck intensity;
baseline comparison logic configured to compute a correlation coefficient between composite bottleneck intensity and memory latency across a sliding window of sampling intervals; and
configuration logic configured to:
(i) modify arbitration weights stored in the programmable arbitration weight register when composite bottleneck intensity exceeds a programmable threshold for a sustained interval, and
(ii) adjust weighting coefficients used in computing composite bottleneck intensity when a statistically significant inverse correlation between bottleneck intensity and latency is detected.

10. The system of claim 9, wherein arbitration logic computes weighted priority scores for pending memory requests using base priority, arbitration weight, and queue aging factor.

11. The system of claim 9, wherein modifying arbitration weights prioritizes latency-sensitive memory transactions over bulk memory transactions.

12. The system of claim 9, wherein inverse correlation is determined when a correlation coefficient is negative and exceeds a programmable magnitude threshold.

13. The system of claim 9, wherein detection of inverse correlation causes increased weighting of stall cycle metrics relative to memory latency derived from memory latency.

14. The system of claim 9, wherein the configuration logic further modifies memory channel bandwidth allocation ratios.

15. A graphics processing unit system comprising:
monitoring logic configured to collect memory access sequences corresponding to memory block identifiers;
a transition count table storing observed transitions between memory block states;
a transition probability matrix derived from the transition count table;
prediction logic configured to compute a predicted next-state probability distribution based on the transition probability matrix;
configuration logic configured to generate prefetch control signals identifying predicted memory blocks having probabilities exceeding a programmable confidence threshold; and
control circuitry configured to compute composite bottleneck intensity using stall cycle metrics and throughput deficiency,
wherein reduction in stall cycle metrics resulting from prefetching reduces composite bottleneck intensity in subsequent sampling intervals.

16. The system of claim 15, wherein transition probabilities are computed by dividing transition counts by total outgoing transitions from a corresponding state.

17. The system of claim 15, wherein prefetch control signals include a predicted memory block address and a confidence value.

18. The system of claim 15, wherein the predicted next-state probability distribution is computed using matrix multiplication between a current state vector and the transition probability matrix.

19. The system of claim 15, wherein prefetching is suppressed when composite bottleneck intensity is below the programmable threshold.

20. The system of claim 15, wherein the transition probability matrix is periodically normalized to maintain row sums equal to one.

21. A non-transitory computer-readable storage medium storing instructions that, when executed by a graphics processing unit including streaming multiprocessors, monitoring logic, arbitration logic, and configuration logic, cause the graphics processing unit to:
compute achieved throughput over sampling intervals;
compute stall cycle metrics;
compute throughput deficiency relative to a stored peak sustainable throughput value;
compute composite bottleneck intensity based on throughput deficiency and stall cycle metrics;
determine whether composite bottleneck intensity exceeds a programmable threshold for a sustained interval;
dynamically modify a number of active streaming multiprocessors;
modify arbitration weights in a shared cache; and
optionally generate prefetch control signals based on transition probabilities derived from memory access sequences.

22. The computer-readable storage medium of claim 21, wherein determining whether composite bottleneck intensity exceeds the programmable threshold further includes detecting inverse correlation between composite bottleneck intensity and memory latency.

23. The computer-readable storage medium of claim 21, wherein dynamically modifying the number of active streaming multiprocessors includes updating a core enable mask register.

24. The computer-readable storage medium of claim 21, wherein modifying arbitration weights alters weighted priority scores used in selecting memory requests.

25. The computer-readable storage medium of claim 21, wherein generating prefetch control signals reduces stall cycle metrics and thereby reduces composite bottleneck intensity in subsequent sampling intervals.
